(19) United States
(12) Patent Application Publication
(10) Pub. No.: US 2009/0293059 A1
(43) Pub. Date: Nov. 26, 2009

(54) AUTOMATICALLY CONNECTING ITEMS OF WORKFLOW IN A COMPUTER PROGRAM

(75) Inventors: Adam D. Nathan, Redmond, WA (US); Andrew Sterland, Seattle, WA (US); Michael J. Leonard, Lake Stevens, WA (US); Timothy S. Rice, Bellevue, WA (US); John I. Montgomery, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/123,473

(22) Filed: May 20, 2008

(51) Int. Cl. G06F 9/46

(52) U.S. Cl. 718/100

(57) ABSTRACT

A workflow design system receives a set of parameters that are to be used in a workflow, as well as an indication of a function that is to be performed in the workflow. The workflow design system uses a mapping component to map the parameters to inputs of the identified function. The workflow design system then outputs suggested mappings of the parameters to the function inputs, and optionally waits for user confirmation. Once user confirmation is received (if it is required), either the workflow design system or the mapping component automatically generates the connections between the parameters and the function inputs.

### BACKGROUND

It is common for computer programmers and developers to design computer programs that involve a workflow. In a workflow, data is entered into the workflow, at some point, and then it is operated on by one or more programming functions. The programming functions perform work on the data, and generate a result of the workflow, which can be output for further processing, output as a final result, or output for other reasons.

The functions, or components, which operate on the data, normally receive one or more input values or variables (parameters), operate on those parameters, or perform some function on them, and generate output values (parameters).

Some current systems use a graphical workflow designer. The graphical workflow designer allows a user to use a mouse to click, drag and drop a plurality of different workflow functions, or components, onto a workflow space on the display screen and then to connect those functions or components together in order to implement a desired workflow. Of course, this is just one way of selecting the workflow functions, and others can be used as well. In many cases, the output of one component of the workflow maps nearly perfectly to the input of a next function or component in the workflow. However, the graphical workflow designer is unable to automatically map the outputs (output parameters) of one component to the inputs (input parameters) of another component. Therefore, users must manually complete this mapping of inputs and outputs, and must manually complete the actual connection of those items together in code. Such a manual task can be quite time consuming and therefore expensive.

The discussion above is merely provided for general background information and is not intended to be used as an aid in determining the scope of the claimed subject matter.

### SUMMARY

A workflow design system receives a set of parameters that are to be used in a workflow, as well as an indication of a function that is to be performed in the workflow. The workflow design system uses a mapping component to map the parameters to inputs of the identified function. The workflow design system then outputs mappings of the parameters to the function inputs. Optionally, the system can receive user confirmation of the mappings as well. Either the workflow design system or the mapping component automatically generates the connections between the parameters and the function inputs.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative embodiment of a workflow design system.

FIG. 2 is a flow diagram illustrating the overall operation of the system shown in FIG. 1.

FIG. 3 is a block diagram illustrating generation of a workflow using workflow components (or objects).

FIGS. 3A and 3B illustrate friendly names and metadata, as well as suggested mappings, respectively, output by the workflow system shown in FIG. 3.

FIG. 4 is a flow diagram illustrating one embodiment of the overall operation of the system shown in FIG. 3.

FIG. 5 is a block diagram of one illustrative computing environment.

### DETAILED DESCRIPTION

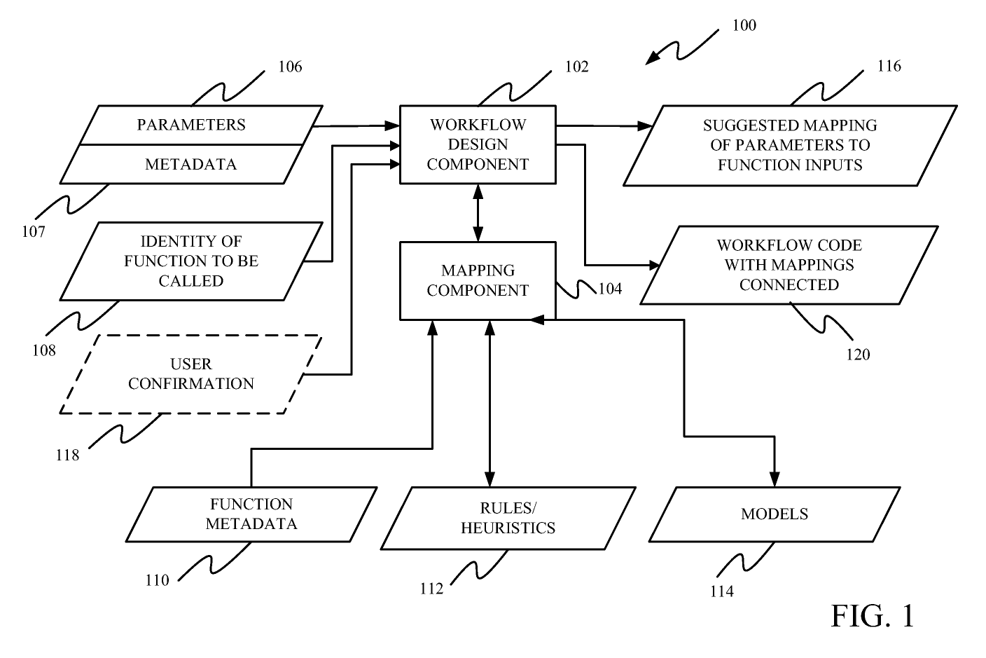

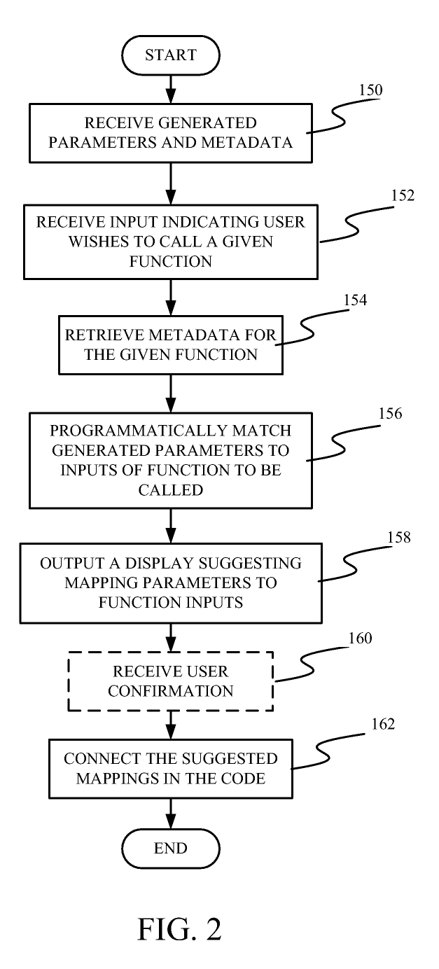

FIG. 1 is a block diagram of one illustrative embodiment of a workflow design system 100. Workflow design system 100 illustratively includes workflow design component 102 and mapping component 104. FIG. 2 is a flow diagram illustrating one embodiment of the overall operation of the system shown in FIG. 1.

A user illustratively uses system 100 to generate a workflow in which data is input into the workflow, operated on, and in which a result is generated based on the operations on the input data. The workflow may include a plurality of different workflow components, each of which perform different operations on data within the workflow. The workflow components may illustratively be functions, components such as objects that expose application programming interfaces, web services that expose application programming interfaces, or other blocks of code that optionally receive an input and optionally generate an output. Some functions or blocks of code both receive an input and generate an output. Others such as data blocks, might only provide outputs. Still others, such as a block that only changes internal state based on an input, might only receive inputs.

In the system shown in FIG. 1, a user has generated or identified parameters 106, that are to be input to a component of the workflow being designed. The parameters can be any of a wide variety of desired parameters, such as global variables, local variables, the outputs of a workflow component that has already been implemented in the workflow being designed, etc. In any case, the parameters 106 are also illustratively accompanied by metadata 107 describing the parameters. The metadata may include any of a wide variety of different features, such as the data type of the parameters, an informal textual description of the data (such as “photo”, “longitude”, “city name”, “person's first name”, etc.), whether the data includes a single value or an array of values, or any other desired metadata which might help in determining the particular inputs to a function the parameters should be mapped to. For instance, the metadata may also include other things, such as possible synonyms, the author of the parameters, any tags associated with the parameters, etc. Receiving the parameters and metadata 106 is indicated by block 150 in FIG. 2.

Workflow design component 102 then receives an indication by the user of the identity of a particular function to be called, given the parameters 106. The identity of the function to be called is indicated by block 108 in FIG. 1 and receiving the user input indicating the function is indicated by block 152 in FIG. 2.

For example, assume that the function to be called 108 is a function which receives, as parameters, longitude and latitude values, and function 108 inserts those longitude and latitude values on satellite photographs retrieved from a database of satellite photography. This is, of course, a function that is discussed by way of example only, and any other function can be used as well.

In any case, workflow design component 102, having received parameters 106 and the associated metadata 107, and having received an identification of the function 108 that is to be called in the workflow being designed, accesses mapping component 104 which maps the parameters 106 to the inputs of function 108, based on the metadata 107 associated with the parameters 106.

In doing so, mapping component 104 first obtains function metadata 110, which is similar to the metadata 107 describing parameters 106. In other words, the function metadata describes the inputs to the given function 108 identified by the user. Therefore, the function metadata 110 can illustratively describe the type of data expected by each input to the function, a textual description (or name) of each input to the function, the expected author of the data to be received, synonyms, whether the expected variables are local or global, etc. Retrieving the function metadata 110 is indicated by block 154 in FIG. 2.

Mapping component 104 then compares metadata 107 with metadata 110, in order to programmatically identify matches between parameters 106 which are to be received by function 108, and the inputs to the function 108. In order to identify these matches, mapping component 104 can use rules or heuristics 112, or can use models 114, which are initially trained, and then updated, as the user uses system 100.

In one embodiment, mapping component 104 uses rules/heuristics 112 or models 114 to perform text-based mapping. In performing the text-based mapping, mapping component 104 compares the textual strings in metadata 107 and metadata 110 to look for similarity. For instance, if one of the text strings that identifies parameters 106 is “longitude” and one of the text strings that identifies an input to function 108 is “longitude” then mapping component 104 will illustratively identify the parameter 106 with the “longitude” name as a suggested input value to the particular input to function 108 that also includes “longitude” as its name in its metadata 110.

Of course, other matching techniques can be used as well. For instance, data-type based matching can be used. In that case, mapping component 104 maps the data type of certain inputs to function 108 with corresponding data types of parameters 106 that are to be input into function 108. The data types are illustratively identified in metadata 107 and metadata 110, for the parameters 106 and the function 108, respectively.

Mapping component 104 can also perform matching using models or other metadata based approaches as well. Those mentioned above are simply mentioned for the sake of example. In some embodiments, certain types of matching may be hierarchically deployed. For instance, data type matching may be first, and only if it matches (the parameter data type is the same or a subtype of the functional input data type), and there are multiple data type matches for a given parameter, then text-based matching is used as a tie breaker. Programmatically matching the generated parameters to the inputs of the given function is indicated by block 156 in FIG. 2.

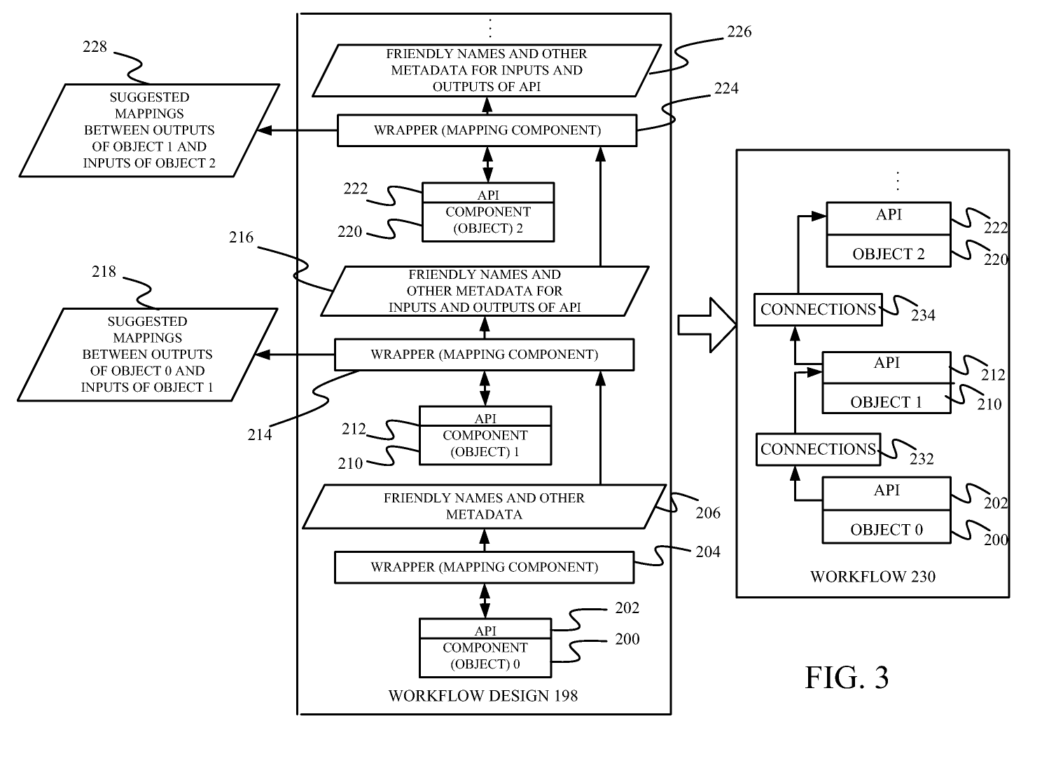

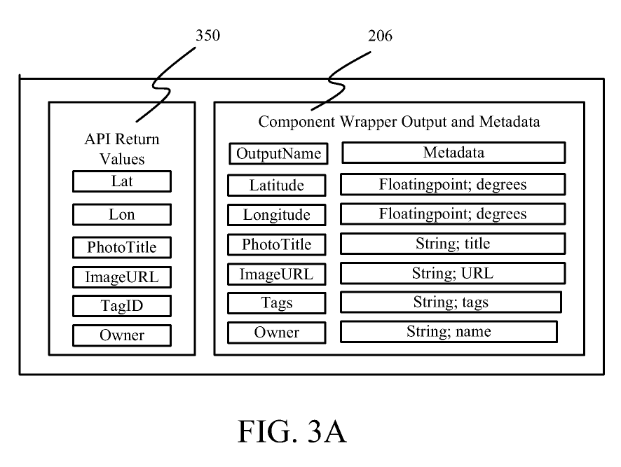

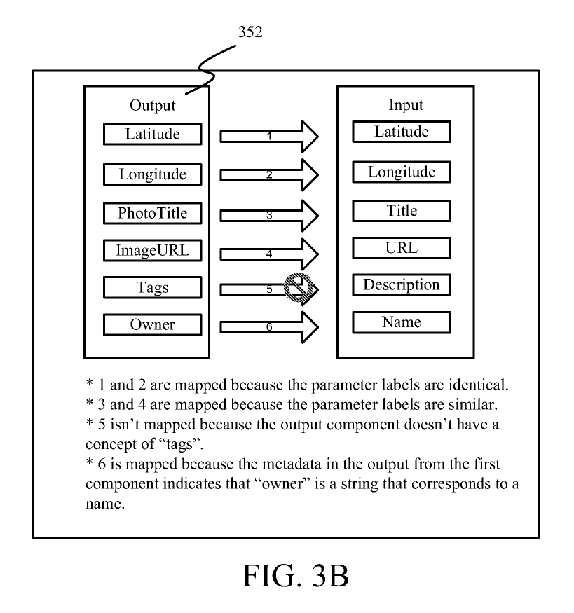

Having generated the potential mappings between parameters 106 and the inputs to function 108, workflow design component 102 illustratively outputs a display, displaying the suggested mappings of parameters 106 to the inputs of function 108. The suggested mapping is indicated by block 116, and outputting the display of the suggested mapping 116 is indicted by block 158 in FIG. 2. A more specific example of one type of display of the suggested mappings is discussed in more detail below with respect to FIGS. 3A and 3B.

Having output the suggested mappings, workflow design component 102 can automatically generate the code to connect the given parameter 106 with the given input to function 108. Alternatively, component 102 can wait to receive user confirmation 118 confirming the suggested mappings. This is indicated by block 160 in FIG. 2. The user confirmation can take any desired form, such as the user clicking a preview button without making any modifications to the suggested mappings, such as the user clicking an “ok” box on a graphical user interface, such as the user simply hovering over a suggested mapping and clicking, etc. It should also be noted that if the user is not satisfied with the suggested mapping, the user can edit the suggested mapping and then submit it to have the actual connections generated.

Once workflow design component 102 has received user confirmation of a suggested mapping (if that is required), it automatically generates the code to connect the given parameter 106 with the input to function 108, displayed in the suggested mapping. Performing this connection is indicated by block 162 in FIG. 2, and the workflow code with the mappings actually connected is indicated by block 120 in FIG. 1.

FIG. 3 is a more detailed data flow diagram illustrating how the mapping can be performed using a graphical workflow design system. In the embodiment shown in FIG. 3, the implementation of mapping component 104 is performed by creating an abstraction layer on top of existing application programming interfaces (APIs) exposed by workflow components (such as blocks or objects). The abstraction layer may illustratively be implemented in the form of a wrapper, or other type of mapping component. In the exemplary embodiment discussed in FIG. 3, the APIs are exposed by web services.

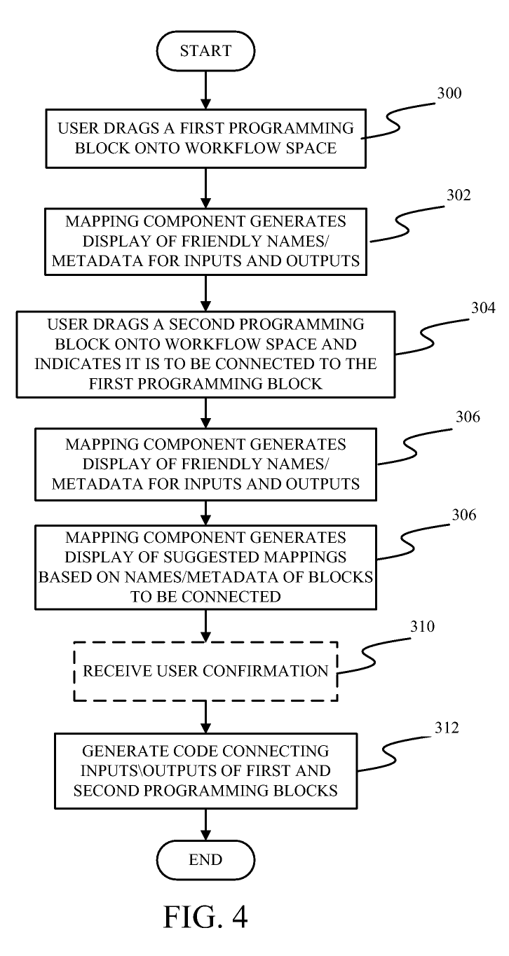

In order to design a workflow using the systems shown in FIG. 3, a user first drags a programming block, such as component (or object) 0 identified by number 200 in FIG. 3, onto a workflow design space of the display screen. This is performed using known drag and drop technology, and the user simply drags component 200 from a library of programming blocks or programming components and drops it on a workflow design space. Of course, the metadata (or heuristics which can include use of mapping component 104) or a model) can also help with selection of component 200. Once parameters are for the workflow are identified, the system can generate a suggestion, as an output, of one or more workflow components having inputs or outputs that match the parameters. Component 200 illustratively exposes an API 202 that receives inputs for component 200 and provides outputs generated by component 200 operating on the inputs. Having user drag and drop the programming component (or block) 200 onto workflow design space 198 is indicated by block 300 in FIG. 4.

Mapping component 104 is implemented as wrapper 204 which, itself, is illustratively an object that can call the underlying component 200 using API 202. In order to make it easier to map the outputs of component 200 to the inputs of other objects or components dragged and dropped into the workspace 198 by the user, mapping component (or wrapper) 204 maps the return values of API 202 to friendly names and other metadata. The friendly names are illustratively user friendly text strings that identify the content of the return value, and the other metadata can take the forms discussed above, or other forms, as desired. Generating the friendly names and other metadata 206 is indicated by block 302 in FIG. 4.

FIG. 3A illustrates one illustrative embodiment of API return values 350 along with corresponding output names and metadata 206 generated for one illustrative component (or object) 200. In the embodiment shown in FIG. 3A, the API return values are labeled as LAT, LON, PhotoTitle, ImageURL, TagID, and Owner. The friendly names generated by wrapper 204 for those API return values are “latitude”, “longitude”, “phototitle”, “imageURL”, “tags”, and “owner”, respectively. The metadata generated for each API return value shows a data type, and also a description of the content of the data. For instance, the metadata generated for the “latitude” API return value is “floating point; degrees”. This indicates that the data type is a floating point variable and it is indicated in degrees.

In continuing to design the workflow, the user of the workflow design system illustratively drags and drops a second computing block onto workflow design space 198, such as workflow component (or object) one designated by block 210 in FIG. 3. Component 210 illustratively exposes an application programming interface 212, and mapping component 104 is illustratively implemented as wrapper 214, which is similar to wrapper 204. The user also illustratively indicates that component 210 is to be connected to component 200 in the workflow being designed. This may be as simple as drawing a line between the two components on the graphical workflow designer display screen. In any case, dragging and dropping the second component 210 onto the workflow design space 198 and indicating that it should be connected to component 200 is indicated by block 304 in FIG. 4.

Wrapper 214 then calls the underlying component 210, using API 212, and generates a display of the friendly names and other metadata for the inputs and outputs of component 210. This is indicated by block 306 in FIG. 4, and the friendly names and other metadata are indicated by block 216 in FIG. 3.

Wrapper 214 also receives the friendly names and other metadata 206 generated for component 200, because components 200 and 210 are to be connected in the workflow being designed. Wrapper 214 then illustratively generates a display of the suggested mappings between the outputs of component 200 and the inputs to component 210, based on the friendly names and other metadata 206 and 216. The ways in which wrapper 214 generates the suggested mappings 218 are discussed above with respect to FIGS. 1 and 2. Briefly, wrapper 214 can use rules or heuristics 112, models 114, or any other desired mechanism, for mapping the outputs of component 200 to the inputs of component 210. Generating the display of the suggested mappings is indicated by block 308 in FIG. 4.

FIG. 3B shows, in greater detail, one illustrative embodiment of a display output by wrapper 214 showing suggested mappings between the output 352 of component 200 and the inputs 354 of component 210. Wrapper 214 illustratively maps the output 352 having a name “latitude” with the input 354 having a name “latitude” because the names have an exact match. Also, of course, they will both be floating point data in degrees, and therefore, the data types will also be an exact match. The same is true of the longitude output 352 and the longitude input 354. Wrapper 214 also suggests a mapping between the output “PhotoTitle” and the input “title” because both have the substring “title” in the name. Also, they both have a data type of “strings” and a description of “title”.

Similarly, wrapper 214 determines that the output name “ImageURL” should very likely be mapped to the input having a name “URL” because they both include the substring “URL”. In one embodiment, data type matching is performed first, and only then is this type of text matching performed. Wrapper 214 will also illustratively suggest a mapping between the output 354 with the name “owner” and the input 352 with the name “name” because the metadata 206 for the output “owner” includes an alternate term “name” to match against.

The output 352 having a name “tags” is not matched to any input 354. The inputs to the programming block represented by inputs 354 simply do not have an input which clearly maps to the “tags” output 352, and therefore no match is suggested. The user may illustratively manually match the “tags” output to an input 354, or simply leave the output as a value which is not received as an input 354.

In any case, after wrapper 214 has suggested the mappings 218 between the outputs of component 200 and the inputs of component 210, the user can confirm the suggested mappings in any desired way. Receiving the user confirmations is indicated by block 310 in FIG. 4.

Wrapper 214 then illustratively generates the code that actually connects the outputs from component 200 to the inputs of component 210 that are confirmed in the suggested mappings 218. This is indicated by block 312 in FIG. 4.

Of course, it will be noted that the same process can be repeated for additional workflow processing blocks, such as component 220 which has an API 222 and an associated wrapper 224. In that case, wrapper 224 receives the friendly names in metadata 216 describing the outputs of component 210 and generates friendly names and metadata 226 for the underlying component 220. Wrapper 224 also generates suggested mappings 228 between the outputs of component 210 and the inputs of component 220, in the workflow being designed.

The right hand portion of FIG. 3 shows an embodiment of the resultant workflow 230. Workflow 230 shows that component 200 has the outputs of its API 202 connected, through the connections 232 generated by wrapper 204, to the inputs of API 212 for component 210. The outputs of API 212 are connected, through connections 234 which were generated by wrapper 214, to the inputs of API 222 for component 220. The connections 232 and 234 are automatically generated using the mapping component which, in the embodiment illustrated in FIG. 3, is implemented by wrappers 204, 214 and 224 on the underlying components 200, 210 and 220. This process can continue, so long as the user designing the workflow desires to add components and connections within the workflow. It will also be noted that FIG. 3 shows a linear sequence of connected objects in the workflow. However, that is illustrative only. The objects in the workflow can be connected in any desired way, and not just in a linear way.

Table 1 below shows one exemplary embodiment of what actual metadata might look like. The section “getGeo taggedPhotos” illustratively defines the name of the method being invoked, or called, on the API. The section “inputs” defines the parameters that the user can author by default. This is basically the collection of inputs to the function being called. The specific inputs listed are “text” and “number”. The “outputs” section defines the outputs of the method. The “objects” portion of Table 1 defines the specific object types. This is a structure or object that has a plurality of different object fields, each with its own type. The specific information identified in Table 1 includes the name of the field, the type of the field, and whether the field is an array. Table 1 is, of course, exemplary only.

TABLE 1

```
<operation name=“getGeotaggedPhotos” callMode=“auto”>
  <description>Get photos that have a latitude and longitude
and have been tagged as “geotagged”.</description>
  <inputs>
    <input name=“text” required=“true” type=“string”>
      <description>text in title, description, or
tags</description>
      <defaultValue>beach</defaultValue>
      <constraints />
    </input>
    <input name=“number” required=“false”
type=“nonNegativeInteger”>
      <description>maximum number of photos to
return</description>
          <defaultValue>15</defaultValue>
          <constraints />
        </input>
      </inputs>
      <outputs>
        <output isArray=“true” type=“custom” object=“Photo” />
      </outputs>
    </operation>
</operation>
</input>
<objects>
    <object name=“Photo”>
      <field name=“url” type=“imageUrl” isArray=“false” />
      <field name=“thumbnailUrl” type=“thumbnailImageUrl”
isArray=“false” />
      <field name=“originalUrl” type=“imageUrl” isArray=“false”
/>
      <field name=“linkUrl” type=“url” isArray=“false” />
      <field name=“id” type=“numericId” isArray=“false” />
      <field name=“owner” type=“userName” isArray=“false” />
      <field name=“title” type=“title” isArray=“false” />
      <field name=“longitude” type=“longitude” isArray=“false” />
      <field name=“latitude” type=“latitude” isArray=“false” />
      <field name=“dateTaken” type=“date” isArray=“false” />
    </object>
  </objects>
</block>
```

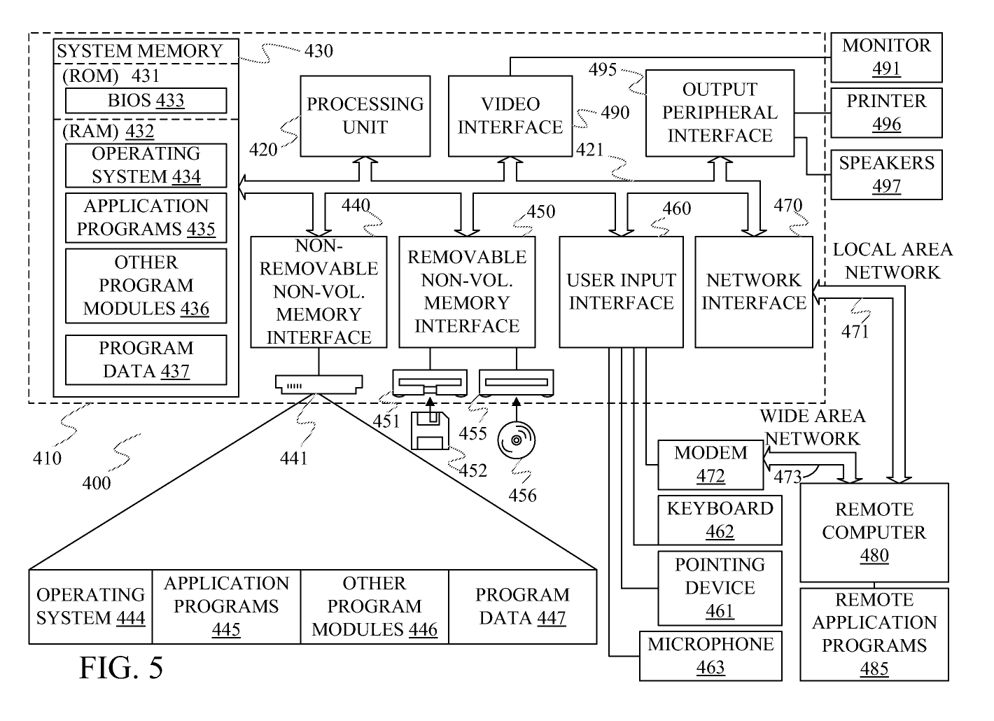

FIG. 5 is one embodiment of a computing environment in which the invention can be used. With reference to FIG. 5, an exemplary system for implementing some embodiments includes a general-purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 5, provide storage of computer readable instructions, data structures, program modules and other data for the computer 410. In FIG. 5, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. The system described above in FIGS. 1-4 can be embodied in programs 445, other programming modules 446, or elsewhere, even remotely.

FIG. 5 shows the clustering system in other program modules 446. It should be noted, however, that it can reside elsewhere, including on a remote computer, or at other places.

A user may enter commands and information into the computer 410 through input devices such as a keyboard 462, a microphone 463, and a pointing device 461, such as a mouse, trackball or touch pad. Other input devices (not shown) may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 is operated in a networked environment using logical connections to one or more remote computers, such as a remote computer 480. The remote computer 480 may be a personal computer, a hand-held device, a server, a router, a network PC, a peer device or other common network node, and typically includes many or all of the elements described above relative to the computer 410. The logical connections depicted in FIG. 5 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 5 illustrates remote application programs 485 as residing on remote computer 480. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A workflow design system, comprising:
a workflow design component receiving a parameter input indicative of function parameters to be input to a given function to be deployed in the workflow and parameter metadata describing the function parameters, and a function identification input identifying the given function, the given function having a set of expected inputs to the function; and
a mapping component receiving function metadata descriptive of the expected inputs to the given function and comparing the parameter metadata and the function metadata, the mapping component generating a suggested mapping output to a user, the suggested mapping output mapping the function parameters to the expected inputs.

2. The workflow design system of claim 1 wherein the mapping component generates code connecting connections between the function parameters and the expected inputs based on the suggested mapping.

3. The workflow design system of claim 1 wherein the function metadata and the parameter metadata each comprise descriptive textual metadata and wherein the mapping component generates the suggested mapping output based on comparison of the descriptive textual metadata.

4. The workflow design system of claim 1 wherein the function metadata and the parameter metadata each comprise data type metadata identifying a data type, and wherein the mapping component generates the suggested mapping output based on comparison of the data type metadata.

5. The workflow design system of claim 1 wherein the function parameters in the parameter input comprise output parameters from a prior given function already chosen by the user for deployment in the workflow.

6. The workflow design system of claim 5 wherein the given function is performed by a first workflow component that exposes the given function through an application programming interface (API), and wherein the mapping component is configured to identify the expected inputs and outputs of the given function through the API for the first workflow component.

7. The workflow design system of claim 6 wherein the mapping component is configured to generate the suggested mapping output after identifying the expected inputs and outputs of the given function.

8. The workflow design system of claim 7 wherein the prior given function is performed by a prior workflow component that exposes the prior given function through an API, and wherein the mapping component is configured to identify the function parameters through the API of the prior workflow component and to generate the suggested mapping output after identifying the function parameters.

9. The workflow design system of claim 1 wherein the mapping component includes a set of rules for generating the suggested mappings based on comparing the parameter metadata and the function metadata.

10. The workflow design system 1 wherein the mapping component includes a set of heuristics for generating the suggested mappings based on comparing the parameter metadata and the function metadata.

11. The workflow design system of claim 1 wherein the mapping component includes a model for generating the suggested mappings based on comparing the parameter metadata and the function metadata.

12. The workflow design system of claim 1 wherein the suggested mapping output includes a graphical display showing named input parameters connected, according to a suggested connection, to named function parameters.

13. A method of generating a workflow, comprising:
receiving a first user input indicative of a user selecting a first workflow component for inclusion in the workflow, the first workflow component receiving inputs and generating outputs;
receiving a second user input indicative of a user selecting a second workflow component for inclusion in the workflow, the second workflow component receiving inputs and generating outputs;
receiving a user connection input indicative of an indication that the first and second workflow components are to be connected in the workflow;
generating a suggested mapping indicating suggested connections between the outputs of the first workflow component and the inputs to the second workflow component; and
outputting the suggested mapping for display to the user.

14. The method of claim 13 wherein receiving the first user input comprises:
receiving a drag and drop input indicative of the user dragging the first workflow component onto a workflow design space on a graphical user interface.

15. The method of claim 14 wherein receiving the second user input comprises:
receiving a drag and drop input indicative of the user dragging the second workflow component onto the workflow design space on the graphical user interface.

16. The method of claim 15 wherein generating a suggested mapping comprises:
identifying the outputs from the first workflow component through an application programming interface of the first workflow component;
obtaining metadata describing the outputs of the first workflow component;
identifying inputs to the second workflow component through an application programming interface of the second workflow component;
obtaining metadata describing the inputs of the second workflow component; and
comparing the metadata for the outputs of the first workflow component with the metadata for the inputs of the second workflow component.

17. The method of claim 16 wherein generating a suggested mapping comprises:
generating a display on the graphical user interface showing individual outputs of the first workflow component mapped to individual inputs of the second workflow component based on the comparison of the metadata.

18. The method of claim 17 and further comprising:
automatically generating code connecting the outputs of the second workflow component to the inputs of the second workflow component shown in the display.

19. The method of claim 16 and further comprising:
Generating an output suggesting an additional workflow component based on one of the metadata obtained, using heuristics and using a model.

20. A computer readable medium encoded with computer readable instructions which, when executed by a computer, cause the computer to perform steps of:
generating a graphical user interface with a workflow design space thereon;
receive a user drag and drop input indicative of a user selecting a first object, having a first application programming interface (API), for deployment in the workflow, the first object receiving inputs and providing outputs through the first API;
receive a user drag and drop input indicative of a user selecting a second object, having a second application programming interface (API), for deployment in the workflow, the second object receiving inputs and providing outputs through the second API;
receiving a connection input through the graphical user interface indicative of the user connecting the first workflow component to the second workflow component;
comparing first metadata describing the outputs of the first object with second metadata describing the inputs to the second object; and
outputting a graphical display of suggested connections between individual ones of the outputs of the first object and individual ones of the inputs of the second object.
